(19) United States
(12) Patent Application Publication
(10) Pub. No.: US 2009/0120931 A1
(43) Pub. Date: May 14, 2009

(54) Flexible Tube Package And Method Of Forming

(75) Inventor: R. Charles Murray, Lakewood Ranch, FL (US)

Correspondence Address: GIFFORD, KRASS, SPRINKLE,ANDERSON & CITKOWSKI, P.C, PO BOX 7021, TROY, MI, 48007-7021, US

(73) Assignee: Pouch Pac Innovations, LLC, Sarasota, FL (US)

(21) Appl. No.: 12/264,739

(22) Filed: Nov. 4, 2008

Related U.S. Application Data
(60) Provisional application No. 60/986,353, filed on Nov. 8, 2007.

(51) Int. Cl. B65D 51/00; B26D 7/27

(52) U.S. Cl. 220/200; 53/396

(57) ABSTRACT

The present invention is an improved flexible tube package and a method for manufacturing the pouch. The package includes a panel having a wall with reinforcing tape that forms a tube. A fitment is sealed around the open edges of the tube. The fitment may be an end cap that includes an absorbent layer that absorbs liquid, moisture, and/or oxygen, a flavor additive and/or a radio frequency identification label. The method includes the steps of forming a pouch by positioning a panel of material, and securing a reinforcing tape on the panel, and sealing the edges to form a tube. An end cap is preloaded into a base of a holder, the formed panel is loaded into the holder, and the base is sealed to an outer surface of the tube. The pouch is opened and filled. An upper end cap is sealed to the upper end of the tube over the reinforcing tape. The pouch is removed from the machine.

### CROSS-REFERENCE TO RELATED APPLICATION

This application claims priority of U.S. Provisional Patent Application Ser. No. 60/986,353 filed Nov. 8, 2007, which is incorporated herein by reference.

### FIELD OF THE INVENTION

The present invention relates generally to a flexible pouch for packaging a product and, more specifically, to a flexible tube for packaging a product and a method of manufacturing the same.

### BACKGROUND OF THE INVENTION

Various types of disposable, portable containers are known in the art for storing a fluid or dry product, such as a liquid, granular material, powder or the like. Examples of containers include a cup, a metal can, a plastic bottle, a glass bottle or a flexible pouch. Consumers prefer the convenience of flexible pouches over other types of containers due to their shape, size, shelf life and storage adaptability. Manufacturers recognize the packaging benefits of a flexible pouch, since the pouch can be formed and filled on the same manufacturing line. An example of a method and apparatus for filling a flexible pouch with a product is disclosed in commonly assigned U.S. Pat. No. 6,199,601, which is incorporated herein by reference.

Flexible pouches have been used for some time to distribute various products, including non-carbonated and carbonated products. An example of a pouch for a carbonated beverage is disclosed in commonly assigned PCT Patent Application No. PCT/US03/034396, which is incorporated herein by reference. With certain types of products, moisture may be present due to the nature of the product. However, the presence of moisture may be undesirable. An example of a product is a fresh food product, such as chicken, or tuna or the like.

While the above-described pouches work well, their use is limited with certain types of products. Thus, there is a need in the art for a flexible tube style package having a fitment, and an improved method of making and filling a such a package, that can be used to store and dispense various types of products.

### SUMMARY OF THE INVENTION

Accordingly, the present invention is an improved flexible tube package and a method for manufacturing the pouch. The package includes a panel having a wall with reinforcing tape that forms a tube. A fitment is sealed around the open edges of the tube. The fitment may be an end cap that includes an insert such as an absorbent layer, a flavor additive and/or a radio frequency identification (RFID) label.

The method includes the steps of forming a pouch by positioning a panel of material, and securing a reinforcing tape on the panel, and sealing the edges to form a tube. An end cap is preloaded into a base of a holder, the formed panel is loaded into the holder, and the base is sealed to an outer surface of the tube. The pouch is opened and filled with a product. An upper end cap is sealed to the upper end of the tube over the reinforcing tape and the pouch is removed from the machine.

One advantage of the present invention is that a flexible tube-shaped pouch and an improved method of making the flexible tube-shaped pouch is provided. Another advantage of the present invention is that a flexible tube-shaped pouch and method of making is provided that includes an end cap that can absorb liquid, moisture, and/or oxygen. The end cap can also include a flavor additive and/or a radio frequency identification label. Still another advantage of the present invention is that a flexible tube-shaped pouch and the method of making is provided that is more cost effective to manufacture, since it the package can be formed, filled and sealed on the same line. A further advantage of the present invention is that a flexible pouch and method of making a flexible pouch is provided that includes a cap fitment heat or ultrasonically sealed to the walls of the pouch.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is an exploded perspective view of an embodiment of a flexible tube package according to the present invention;

FIG. 2 is a perspective view of the embodiment shown in FIG. 1 with a product within the flexible tube package;

FIG. 3 is a side cross-sectional view of the bottom end cap shown in FIG. 1;

FIG. 4 is an enlarged side cross-sectional view of a portion of the bottom end cap shown in FIG. 3;

FIG. 5 is a top perspective view of a removable end cap for the flexible tube pouch shown in FIG. 1;

FIG. 6 is top perspective view of an end cap with a spout;

FIG. 7a is a perspective side view illustrating a folded flat seam for a flexible tube package;

FIG. 7b is a side view of a flexible pouch with a folded flat seam;

FIG. 8 is a side view of a flexible pouch with a seal strip covering the flat seam;

FIG. 9a is an elevational view of a pouch having an integrally formed gusset and an overlap flat seam;

FIG. 9b is a detail view of the overlap flat seam shown in FIG. 9a;

FIG. 10a is an elevational view of a pouch with an overlap flat seam in a side gusset;

FIG. 10b is a detail view of the overlap flat seam in the side gusset shown in FIG. 10a;

FIG. 11a is an elevational view of a panel for a pouch with an overlap S-type flat seam;

FIG. 11b is a sectional view of a pouch formed using the panel of FIG. 11a;

FIG. 11c is a detail view of the S-type flat seam shown in FIG. 11b; and

FIG. 12 is a schematic diagram illustrating a process for making a flexible tube package.

### DETAILED DESCRIPTION OF THE INVENTION

The present invention discloses a flexible tube package and a method for making a flexible tube package. As such, the flexible tube package has utility as a container to hold a product and the method has utility for making a container that holds a product.

The flexible tube package includes a panel that has a pair of side edges, the panel being rolled into a tube shape such that the pair of side edges are proximate to each other. The side edges are sealed with a side seal in order to form a tube out of the panel, the tube having a tube inner surface and a tube outer surface. An elongated piece of reinforcement tape is attached to at least one end of the tube. The tube package also includes a first end cap attached to one end of the tube and a second end cap attached to an opposite end of the tube. In addition, an insert such as an absorbent layer is located within the flexible tube package. The absorbent layer can absorb liquid, moisture and/or oxygen. In addition, the insert can be a flavor additive and/or RFID label. In some instances, the elongated piece of reinforcement tape is attached to the tube inner surface. The first end cap can have a side wall that extends from an end portion, the side wall having a side wall inner surface that is attached to the tube outer surface. The first end cap can also have a false bottom made from a perforated layer that is spaced apart from the end portion of the cap. It is appreciated that the absorbent layer, flavor additive and/or RFID label can be located within the false bottom, that is between the end portion and the spaced apart perforated layer. The flexible tube package can include other items or features such as a pressure release valve, a radio frequency identification tag and the like.

The process for making the flexible tube package includes providing a roll of laminate material, unrolling the roll of laminate material and attaching the elongated piece of reinforcement tape onto the material. In addition, a panel is cut out of the roll of laminate material and rolled into the shape of a tube. The panel has a pair of side edges that are proximate and generally parallel with each other, thereby providing for forming a side seal extending along the pair of side edges and forming a tube out of the panel. A first end cap is provided and is attached to a first open end of the tube and a second end cap is provided and attached to a second open end of the tube. The absorbent layer that can absorb liquid, moisture and/or oxygen is included and provided within the flexible tube package, and in some instances is located within the false bottom of the first end cap. The flavor additive and/or RFID label can also be included and located within the false bottom of the first end cap.

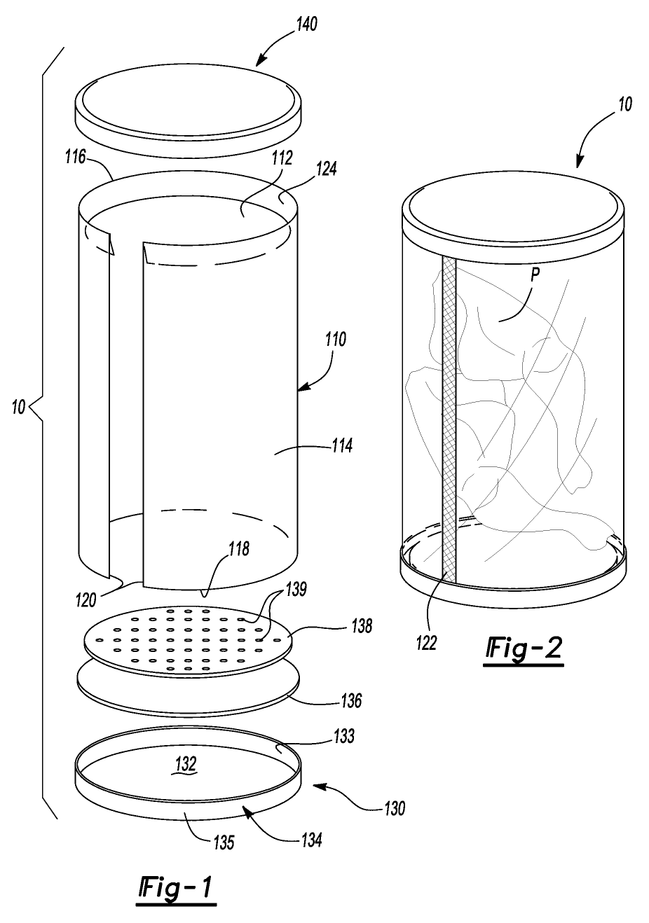

Referring now to FIGS. 1 and 2, a flexible tube pouch is generally illustrated at reference numeral 10. The tube pouch 10 may be filled with a product P and sealed. The tube pouch 10 may have a generally cylindrical shape, a cubical shape, an hourglass shape, a barrel shape or another shape. It is contemplated that the tube pouch 10 may contain a single portion or multiple portions of the product P. In this example, the product P is a meat, such as poultry or fish or the like. The product P may be fully prepared, partially prepared, or raw.

The flexible pouch 10 is preferably formed from a roll of preprinted material of extruded or laminate layers. The material is typically a three, or four, or five or more gauge material, two laminations of material or the like. The outer layer is usually preprinted. Alternatively, at least a portion of the material may be not printed, i.e. translucent, in order to view the product P contained therein. The clear portion could also be in a gusset or insert. The outer layer of material may be a sleeve with preprinted information.

The choice of sheet layer material is non-limiting, and is influenced by factors such as the product contained in the pouch, the shape of the pouch, or the anticipated use of the pouch. One example of a laminate material structure includes at least one layer of virgin polyethylene terephthalate (PET), at least one layer of aluminum foil and another layer such as EVOH, PET, polyethylene or nylon or the like. Another type of laminate material structure may also include a metalized foil paper layer laminated to a cast polypropylene layer and another layer of PET, polyethylene or EVOH. There may be a fourth layer of nylon. Similarly, the laminate structure may include a cast polypropylene (CPP) layer, a polyethylene (PET) layer, a foil (AL) layer, a nylon (ONO) layer and another CPP layer. Another structure is the use of nylon, foil, nylon and cast polypropylene (ONO/AL/ONO/CPP) or CPP/NY/AL/CPP. Another example of a material structure is ONO/AL/COEX-ONO-LDPE. Still another is PET/AL/NYLON/CPP. Material structures that include CPP are well suited for packaging a beverage having an alcoholic content, such as wine or beer or another liquor, to add strength to the walls of the pouch, and to preserve the product. CPP and nylon protect the AL layer from cracking. Carbonation is beneficial since it acts as a microbiocide and preserves the flavor and aroma of the products. The use of cast polypropylene laminate material also assists in retaining the filled shape of the container, even as the product is removed from the pouch 10. A further example of a laminate material structure is CPP/AL/ONO/PE. This structure works well when the product has a short shelf life, and the nylon eliminates stretching or cracking of the AL layer.

For a white wine product, an example of a material structure is PET/EVOH/PE or AL/PET/NY/PE. Similarly, a material structure for a red wine product includes PET/EVOH/PE, or AL/NY/PET/PE. Still another example of a material structure is a seven-layer structure that includes a co-extruded laminate, such as PET/CO-PP/AL/NY/LLDPE, or the like. It should be appreciated that the CO-PP layer can include multiple layers, such as three in this example. Other film structures may also be utilized that offer similar protection from sunlight, as well as organoleptic protection from the development of undesirable flavors.

It should be appreciated that if a filled carbonated pouch is stored at ambient temperature, the laminate will start to creep after a period of time, such as ten days. The laminate material may include an extrusion layer to contain “creepage” or “stretch” of the film after filling due to carbonation expansion of the carbonated product. In addition, the selected material may be organoleptic compliant in order to avoid the transfer of odor contaminates to the product, or product contamination during the shelf life period of the product.

The pouch 10 can be formed from at least one panel 110 of material. The panel 110 has an inner surface 112 that is adjacent the product, and an outer surface 114. The panel is further defined by an upper edge 116, an opposed lower edge 118, and a pair of side edges 120 extending between the upper edge 116 and the lower edge 118. It is appreciated that the terms “upper” and “lower” are used for descriptive purposes only, unless otherwise noted, when referring the figures. As such, “upper” can be “lower” and “lower” can be “upper” when referring to an actual flexible tube pouch. The side edges 120 of the panel 110 can be sealed to form a sealed seam 122. The pouch may include a reinforcement tape 124 to provide structural support. In some instances the reinforcement tape 124 is a piece of elongated reinforcement tape. The reinforcement tape 124 can be placed along and/or attached proximate the upper edge 116 and/or the lower edge 118 of the panel 110. In addition, the reinforcement tape 124 may have a plurality of ridges to assist in securing the cap to the pouch and may be attached to the inner surface 112 and/or outer surface 114 of the panel 110.

The pouch can include an end cap 130, the end cap 130 having a generally planar end portion 132 and an upstanding side wall 134 extending from an edge of the end portion 132. The end cap 130 may be removably or permanently attached to the pouch 10. It is appreciated that the flexible tube pouch 10 may include an end cap enclosing each open end of the tube panel. Various materials may be utilized for the end cap, such as foil, cardboard, nylon, laminate, or a heat sealable plastic such as LLDPE, polypropylene PP, reground resin, food grade polyethylene PE or the like. Further, the end cap 130 may be formed from a printed material, or it may be clear.

The end cap 130 may include an insert 136 positioned on an inner surface, the insert 136 being an absorbent layer that absorbs liquid, moisture and/or oxygen, a flavor additive and/or an RFID label or tag. For example and for illustrative purposes only, the end cap 130 can have a perforated layer 138 with one or more apertures 139. The perforated layer 138 can be spaced apart from the end portion 132 and afford for a false bottom to be present within the end cap 130. The insert 136 can be located within the false bottom, i.e. between the end portion 132 and the perforated layer 138. In some instances, the perforated layer 138 can be attached to the end cap 130, for example the perforated layer 138 can be sealed and/or attached to the inner surface 133 of the end cap side wall 134.

The insert 136 serves can serve as an absorbent layer to absorb any liquid, moisture and/or oxygen that forms in the pouch due to the product. An example of an absorbent layer material is an open cell foam material such as Dri-Fresh® absorbent pads provided by Sirane Ltd. located in Telford, UK. The insert 136 can also serve as a flavor release aroma additive and/or an RFID label.

The insert 136 can have the same shape as the end cap 130, or another shape. The dimensions and/or absorbency of an absorbent layer material are selectively determined by the amount of absorption desired. For example, absorbency grades ranging from 800 cubic centimeter per square meter (cc/m²) to 13,000 cc/m² are known. The insert 136 may also be secured to the end cap, such as by an adhesive compatible with the product contained therein. The insert 136 in the form of an absorbent layer can channel moisture away from the product and in combination with the false bottom of the end cap 130 can prevent unsightly accumulation of liquid within the flexible tube pouch 10.

For a permanent end cap, an inner surface 133 of the end cap side wall 134 is sealed to the outside surface 114 of the panel 110. Alternatively, an outer surface 135 of the end cap 134 can be sealed to the inner surface 112 of the panel 110. The seal may be an ultrasonic welded seal or a heat weld, a combination of both, or the like.

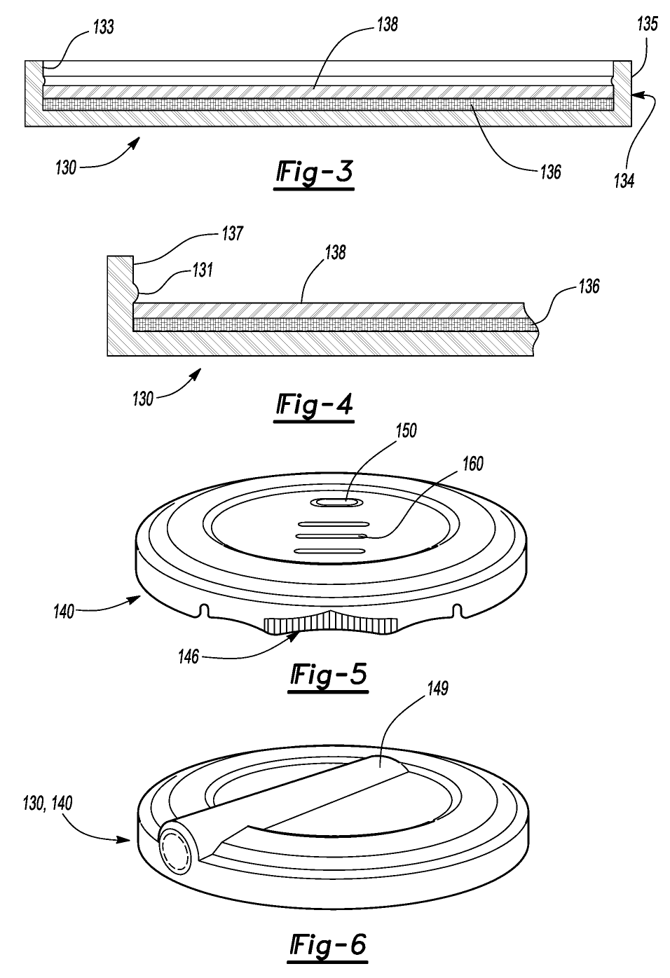

The inner surface 133 or outer surface 135 of the end cap side wall 134 may include a seal-engaging surface 137. The seal-engaging surface 137 may be smooth. In another example, the seal-engaging surface can have a plurality of outwardly projecting ribs 131, in order to provide an increased retention surface between the end cap 130 and wall of the pouch 10. The seal-engaging surface 137 is fixedly secured to the inner surface 112 or outer surface 114 of the flexible pouch 10 in a manner to be described. In the example shown in FIGS. 2-4, the inner surface 133 of the end cap 130 is sealed to the outer surface 114 of the panel 110.

The pouch can also include an end cap 140 that may or may not be removable and provides access to the product P within the pouch 10 as illustrated in FIGS. 5 and 6. The removable cap 140 may also be replaceable. As shown in FIG. 5, the removable end cap 140 can include a removal mechanism 142 for removing the cap 140 from the flexible tube pouch 10, such as a tear-off strip or other means for breaking a seal between the end cap 140 and the panel 110. The end cap 140 can also have a spout 149 as shown in FIG. 6, through which a product contained within the pouch 10 can be poured. In this manner, the spout 149 in combination with the absorbent layer 136 affords for a granulated, powdered, etc., product to be contained within the pouch 10 with any moisture, condensate, etc., taken up or absorbed by the layer 136.

It should be appreciated that the flexible tube pouch 10 may advantageously include other features that are known in the art and one or more of the features may or may not be part of one of the end caps. For example, the pouch 10 may include a tracking device 150 feature integrally located within the pouch 10 that includes electronic tracking information relevant to the pouch 10, as described in commonly assigned U.S. patent application Ser. No. 11/686,666, which is incorporated by reference. In an example, the tracking device 150 may be secured on the end cap 130 and/or the end cap 140, or within an airspace or air pocket formed in a sealed portion of the pouch 10 formed during the manufacturing process. The tracking device 150 may be an electronic tag, such as a Radio Frequency Identification (RFID) transmitter. The tracking device 150 can store a predetermined amount of electronic information. An example of the information is unique tracking information for a particular package 10. For example, the tracking device 150 can provide information about the status of the pouch 10, such as physical location of the pouch 10, or age of the pouch 10 or the like. In addition, the tracking device 150 can be utilized for inventory control, delivery, purchase behavior, returns, pricing, and other tracking purposes. The tracking device 150 is in communication with a receiver (not shown) for reading the information. The receiver may be a computer system having a memory and a processor, a handheld device for receiving an RFID signal, or any other type of device capable of electronic communication with the tracking device 150. The receiver may be a transceiver capable of emitting a radio signal that initiates transmission of information from the tracking device 38. Although the packages are individually read, the RFID tag may be advantageously read at a faster rate than using a barcode in conjunction with a barcode scanner, since the packages are not physically scanned on an individual basis. In addition, the signal from the RFID tag may be advantageously read through an outer layer of material, such as a packaging material, or under various environmental conditions. Another advantage is that the tracking of the physical location of the package may be electronically monitored within a predetermined geographical range.

The pouch 10 may also include a feature such as an integral vent means 160. The vent means 160, such as a valve, functions to exhaust a gas from the pouch 10. The gas may be formed within the package while heating the pouch. The valve 160 may also be operable to respire gas formed in the pouch 10 for other reasons, such as gas formed by decaying food or during freezing or the like. The valve 160 remains tightly closed, until pressure from the gas, such as steam, reaches a predetermined pressure value. An example of a predetermined pressure is approximately 3 mbar. The valve opens and remains open, to release the gas from the package in a controlled manner. Various types of valves are contemplated. For example, a tape may be used to cover a hole in the wall. Alternatively, a pressure relief device, such as that manufactured by PPI Technologies, Sarasota, Fla. model number P00T, may be utilized. Another example of a valve is disclosed in commonly assigned U.S. patent application Ser. Nos. 10/228,430 and 10/967,547 and PCT Patent Application No. PCT/US2004/34361.

Another feature that the pouch 10 may include is an angled seal extending between a first side edge and a predetermined location on the edge of the pouch. The angled top seal facilitates the removal of product from the pouch by directing the flow of the product towards the opening means. An example of such a pouch is disclosed in commonly assigned U.S. patent application Ser. No. 11/683,133 which is incorporated herein by reference.

Yet another feature that the pouch 10 may include is a hanging aperture located within an edge, such as an upper edge or side edge. The aperture may have various shapes, such as round or curved. The pouch 10 may be supported by a support means, such as a hook that extends through the aperture. The pouch 10 may be hung for display or storage purposes. The positioning of the hanging aperture above the angled top seal or within a sealed portion prevents the contents of the pouch from leaking out through the aperture.

Still yet another feature the pouch may include is a dimple (not shown) for receiving a straw. Another feature is a weakened portion adjacent the opening means, to facilitate opening the pouch. Still another feature is a straw (not shown) attached to the pouch 10. In still another example, the flexible pouch 10 may include a guide pocket formed in the pouch 10 prior to filling and sealing, to facilitate the separation of the front and back walls prior to the filling of the pouch 10. An example of such a pouch is disclosed in commonly assigned U.S. patent application Ser. No. 11/435,227. In a further example, the pouch may contain a rib that adds strength or support or form to the pouch. The rib may be thermoformed.

Another feature the pouch may include is an ergonomic shape. An example of an ergonomically shaped pouch for a carbonated beverage is disclosed in commonly assigned U.S. patent application Ser. No. 11/454,241 which is incorporated by reference. The ergonomic shape may be achieved through carbonation as the pouch 10 is filled with a carbonated product, since the carbonation causes the pressure within the pouch to increase.

Yet another feature the flexible pouch 10 may include is an outer layer or sleeve covering the outer surface of the pouch. The sleeve may be a label containing information about the product, such as a barcode or the like. The sleeve may cover only a portion of the pouch outer surface. Preferably, the sleeve is shrunk over the outer surface of the pouch 10 after the pouch 10 is formed and filled with the product. The sleeve is advantageous because it covers the side seam. It also adds one or more layers of material to strengthen the pouch and improve its durability. Various types of material may be utilized for the sleeve, such as paper or plastic including PET or PVC and the choice is non-limiting.

It is contemplated that these are merely examples of features and the flexible pouch 10 may incorporate any of the above-described features or any other feature, in any combination. For example, the pouch 10 may include an insert in the bottom portion of the pouch and a tapered top portion, or an insert in the bottom portion of the pouch and a spout and a cap enclosing the top portion of the pouch. In addition, the finished pouch may assume various shapes, such as cylindrical, cubical, and conical, hourglass or the like, as influenced by the type of product and intended usage of the pouch. It should further be appreciated that the upper edge and lower edge may be interchangeable and is merely for reference purposes.

It is also contemplated that the pouch 10 may undergo a secondary process after it is filled with the product. This process may take place on a separate line than the form-fill-seal line. For example, the filled pouch may be refrigerated, frozen or otherwise modified for an extended shelf life. Alternatively, the filled pouch may be pasteurized for increased shelf life. Examples of pasteurized food products include dairy products such as milk, or meat products such as chicken or the like.

The pouch may include two side seams if made from two panels or one single seam if made from one panel. In an example of a pouch formed using a single panel of material, the side edges may be joined along a center seam. The seam may be a flat seam. In an example of a pouch 10 formed using two panels of material, the edges are joined along two side seams. The side seam may be a flat seam or fin seam a folded seam or the like.

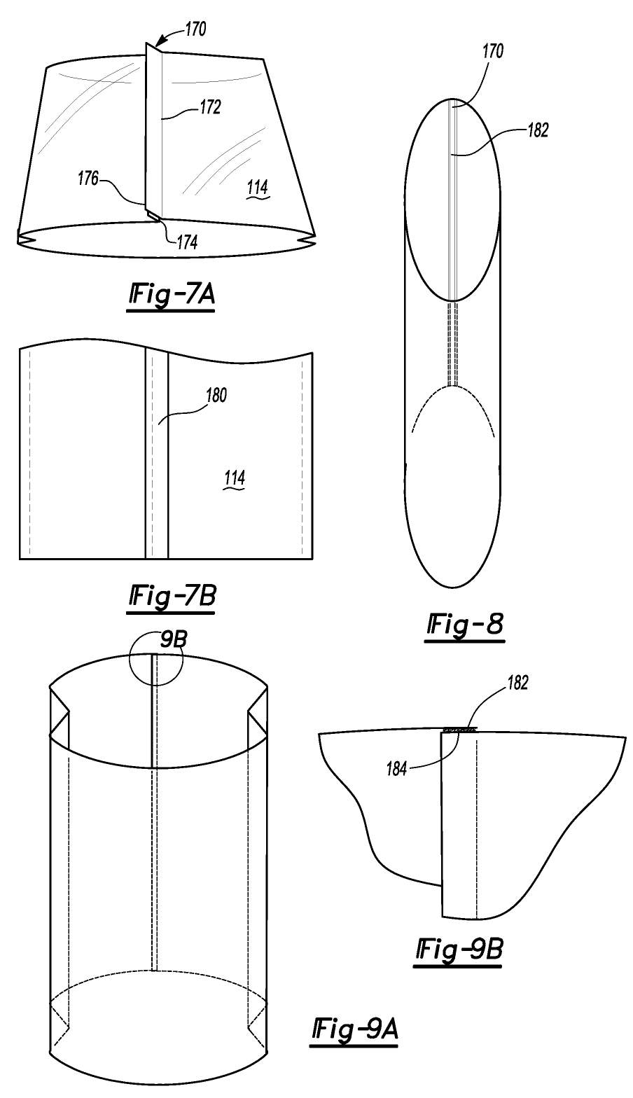

An example of a pouch 10 having a flat seam is illustrated in FIGS. 7a-7b. A flat seam 170 is a folded seam or reverse seal. A first and second side flap includes a fold, as shown by a first fold 172 and second fold 174. The first fold 172 forms an obtuse angle relative to the outer surface 114 and the second fold 174 forms an acute angle. It should be appreciated that only a minimal portion of the first flap extends beyond the second flap. The first flap is positioned over the second flap so that the folds are in alignment and that a portion of the first flap extends beyond the second flap, as shown at 176. The first and second flaps are sealed together in a manner to be described, and the extending edge 176 is folded over to form a flap 180 that can lie flat against the outer surface 114 of the pouch 10. Preferably, the flap 180 is secured to the outer surface 114 of the pouch 10. For example, the flap 180 may be secured along the upper edge 116 and/or the lower edge 118 to the walls of the pouch. Alternatively, the length of the flap 180 may be secured to the walls of the pouch 10. The flap 180 can be secured using a sealing means, such as a tack seal, or an adhesive or monolayer film or the like. In another alternative, the flap 180 may be sealed to the outer surface of the pouch using a second strip 182 of material covering the seam 170, as shown in FIG. 8. The seam cover 182 is secured using a sealing means, such as a weld or an adhesive. The folded seal is advantageous, since it has a higher seal bond strength than a typical layer on layer seal.

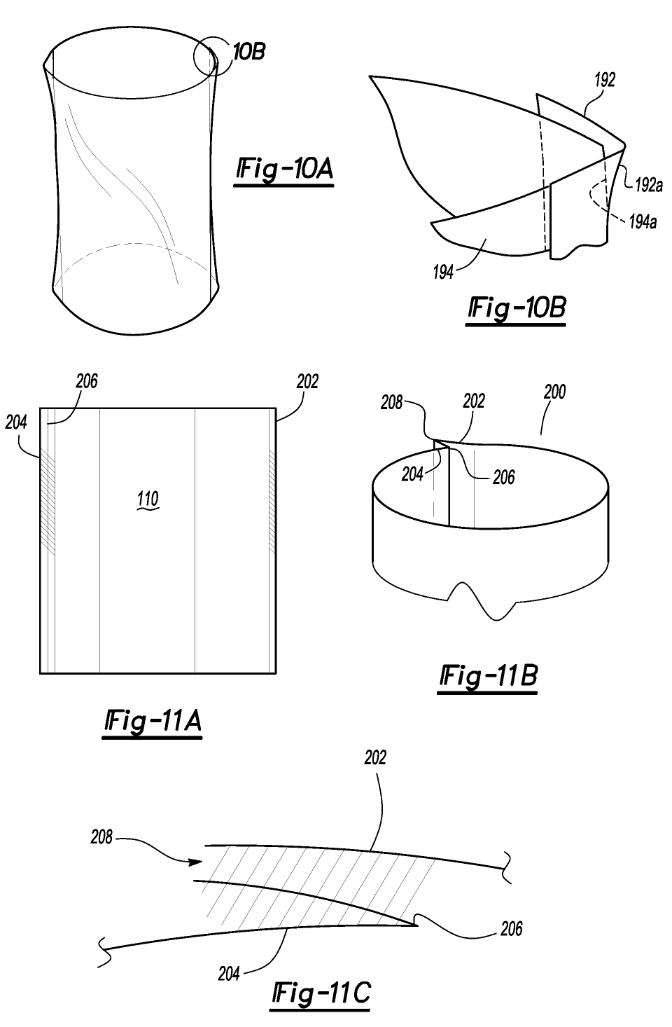

Another embodiment of a pouch with an overlap flat seam is illustrated in FIGS. 9a-10c. In this example, a first side edge 182 overlaps a second side edge 184 a predetermined amount as shown in FIGS. 9a-9b. Alternatively, a first side edge 192 and second side edge 194 may each include a corresponding fold 192a, 194a, as shown in FIGS. 10a-10b. The first side edge 192 is positioned over the second side edge 194 so that the edges overlap. Preferably, the amount of overlap is between 5-12 mm. The first and second edges 192, 194 are sealed together using a technique to be described. It should be appreciated that the inclusion of a CPP layer of material on the inside of the pouch and on the outside improves the seal strength of the overlap seal, since it has a higher bond strength and prevents delamination.

Still another embodiment of a pouch formed from one panel of material and having an overlap flat seam is illustrated in FIGS. 11a-11c. In this example, a first side edge 202 overlaps a second side edge 204 a predetermined amount. The second side edge 204 includes a fold 206 along a seal fold line. The first side edge 202 does not include a fold. The second side edge 204 is folded outwardly 180 degrees along the seal fold line 206, and the first side edge 202 is positioned over the second side edge 204 so that the first side edge 202 is adjacent the folded second side edge 204. Preferably, an outer portion of the first side edge 202 and an outer portion of the second side edge 204 are in alignment with each other and overlap as shown at 208. Preferably, the amount of overlap 208 between the first side edge and second side edge is about 5-12 mm. The first and second edges 202 and 204 are sealed together using a technique to be described. It should be appreciated that the inclusion of a CPP layer of material on the inside of the pouch and on the outside, improves the seal strength of the overlap seal, since it has a higher bond strength and prevents delamination. As previously described, a seam cover may be positioned over the seam and sealed to the outer wall of the pouch.

The pouch 10 may include an insert, side wall or gusset. The gusset may be integrally formed in the panel, or a separate piece of material. The gusset may be disposed between an edge. It should be appreciated that the shape of the gusset is non-limiting. For example, the gusset may be generally wider at one end and taper upwardly towards the opposite end. The gusset may also be of a uniform width. The use of the gusset may be functional, i.e. it may allow the pouch 10 to acquire another shape, such as cylindrical, or to stand upright. The gusset can also enhance the strength and rigidity of the pouch 10 during filling and processing. A side gusset is advantageous since it allows the walls of the pouch to expand as the internal pressure within the pouch increases. A gusset positioned between the lower edges 118 of the pouch 10 may form a base, enabling the pouch 10 to stand upright unsupported.

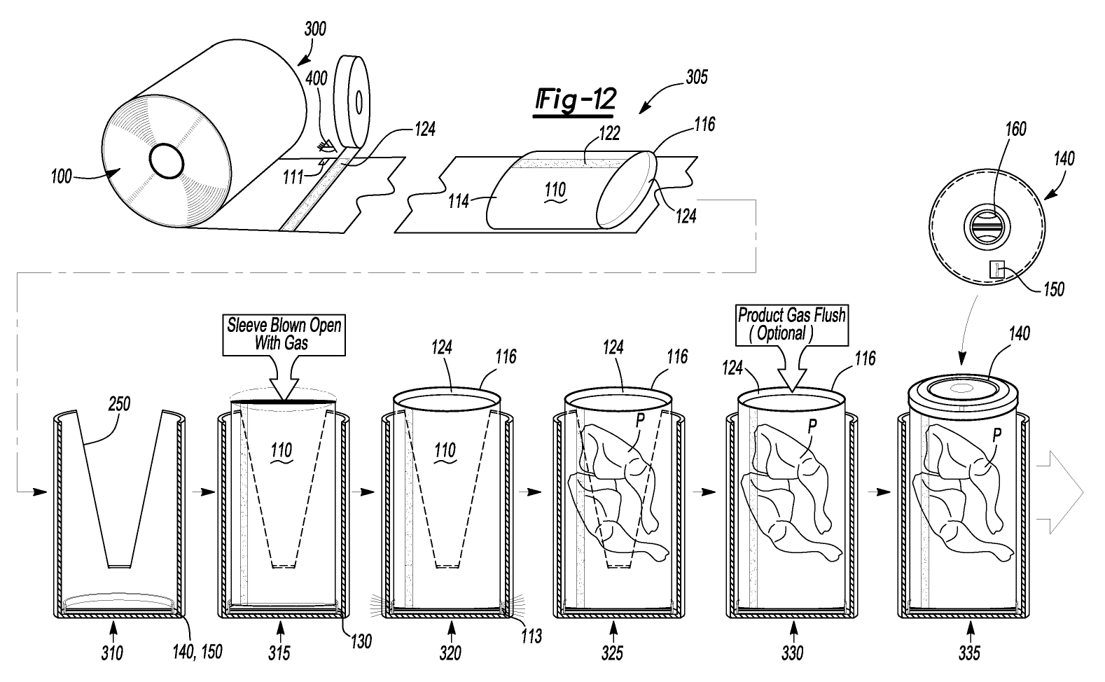

Referring to FIG. 12, a method for forming, filling and sealing the flexible tube pouch 10 using a high-speed machine is illustrated. The method begins at step 300 with a first station initiating the forming of the body of the pouch 10. For example, a roll of laminate material 100, as previously described, is unrolled along a horizontally oriented plane. The initial width of the roll of material 100 is determined by the desired finished size of the tube pouch 10 and the number of pouches to be obtained from the width. For example, three or four or six pouches, representing six to twelve panels, can be obtained from a width of the roll of material 100 on a three-lane machine or four-lane or more machine, respectively. Each panel has an inner surface and an outer surface. One layer of the material is preferably preprinted with information or locating indicia, such as a registration mark 111. The registration marks 111 are located on the material 100 to denote an edge of the panel. The registration marks 111 are read by an optical reading device 400, such as a scanner or registration eye, to index the material in a predetermined position at a cutting station. The preprinted information may include labeling information that describes the product contained within the pouch 10. In this example, the layer of preprinted information is located on an outer layer of the material. An example of a high speed, multiple lane machine for forming a pouch is described in commonly assigned U.S. patent application Ser. No. 11/674,923, which is incorporated herein by reference.

A feature such as the reinforcement tape 124 is optionally positioned and secured to the aligned unrolling section of material. The reinforcement tape 124 can be positioned on the panel of material along the upper edge 116 of the panel 110 before or after the panel 110 is cut from the unrolled section of material 100. The reinforcement tape 124 can also be positioned along the lower edge 118, or along one or both of the side edges 120 of the panel 110 in order to provide support to the pouch 10. Various techniques may be used to secure the reinforcement tape 124 to the panel of material 100, such as welding, use of an adhesive or the like. The reinforcing tape 124 provides structural support for the pouch 10 and assists the pouch in maintaining its shape.

The methodology advances to step 305 where the edges of the walls can be sealed. For example, the side edges 120, the upper edge 116 and/or the lower edge 118 can be sealed. It is appreciated that one edge may be left open for filling purposes. Alternatively, the edges are sealed and the pouch is filled through the fitment. Another seal, such as the angled top seal may also be applied at this time.

The side edges 120 of the walls may be sealed together to form the side seal 122. Various sealing techniques are contemplated. For example, an ultrasonic sealing process may be used. Another technique is a heat weld that includes the application of heat and compression. Advantageously, the seal may be shaped so as to avoid sharp radiuses at the interior corners of the pouch. A rounded interior shape facilitates removal of the product.

In still another example, the edges are sealed using a seal bar or forming plate having a plasma coating. One advantage of the plasma coating is that the line speed may increase. Another advantage is that the coating makes the surface of the seal bar or forming plate more resilient. When the seal bar is heated, the coating expands due to this resiliency. The shear stress on the inner edge of the seal is reduced; resulting in reduced creepage of the material and greater durability of the seal. The plasma coating reduces the opportunity for potential damage to the material during the sealing step. In this example, the plasma coating is a smooth, hard plastic that mimics glass. Since the outer layer of material is not weakened, there is no creepage of the outer layer.

In still another example of a sealing technique, the side seal is a two-step seal. An example of a two-step seal is disclosed in commonly assigned U.S. patent application Ser. No. 11/551,071. The two-step seal advantageously avoids the generation of ketones due to application of heat to the material. The first or inner seal is a low temperature seal. The second or outer seal is a high temperature seal. The second seal is spaced apart from the first seal by a predetermined distance, to create an air gap. The first seal is a tack seal, such as 6 mm wide, and is of a sufficient temperature so as to melt the layers of material and tack the edges together. The predetermined distance between the first and second seal is ½-1 mm. The second seal is applied at a higher temperature and pressure than the first seal. As a result, any gas, such as steam, ketones, aromatics or the like are pushed in an outwardly direction, out through the open edges of the panels, and not into the pouch. Thus, the first seal prevents entry of contaminates into the pouch to avoid organoleptic contamination.

It should be appreciated that the upper edge 116 or lower edge 118 may be further trimmed. For example, an end of the pouch 10 may be trimmed to accommodate a fitment. In another example, two legs are formed during the trimming operation, in order to recess the fitment.

The methodology can advance to a step (not shown) where the pouch is finished, for example, a feature, such as the fitment, as previously described, may be sealed within the walls of the pouch 10, such as between the upper edge 116. The fitment may be sealed using an ultrasonic seal, or a heat weld, or by a combination of ultrasonic seal and heat weld, as previously described. An example of an ultrasonic seal for a fitment is disclosed in commonly assigned U.S. patent application Ser. No. 11/195,906, which is incorporated herein by reference. Accordingly, a base portion of the fitment is sealed to the walls of the pouch using an ultrasonic seal, a heat seal, and then a cool seal. The heat seal melts a layer of the pouch material, and the material can flow around sealing ribs on the base portion and fill in any void between the base portion and the wall of the pouch 10. The cool seal sets the seal and provides an attractive finish to the overall seal. Advantageously, fewer stations are required to seal the fitment between the walls of the pouch, since a tack seal is eliminated.

In addition, an insert may be likewise applied to the pouch 10 at this time. The insert may be positioned at the lower edge 116 of the pouch 10, at the upper edge 118, or at both the upper and lower edge. An edge of the pouch 10 may be trimmed to shape at this step, e.g. the corners may be angled or edges trimmed fitment. It is sometimes advantageous for the pouch corners to have a radius, to eliminate right angles at the corners. A hanging aperture may be formed at this time. This operation may be performed using a cutter or a die cut or the like.

In another example of a finishing operation, a crease or guide pocket may be formed in a top portion of pouch in a creasing operation, in order to facilitate opening and filling of the pouch. An example of a method of forming a crease in a wall to facilitate opening the pouch is disclosed in commonly assigned U.S. patent application Ser. No. 11/435,227, which is incorporated herein by reference. It should be appreciated that the shape of the finished pouch is non-limiting, and may be round, square, oval, triangular or the like. In still another example of a finishing operation, the sleeve is applied over the individual pouch and shrunk to fit using an application of heat to the pouch. A further example of a finishing operation is the formation of a rib, such as a thermoformed rib, to add rigidity to the pouch.

The methodology can also advance to a step (not shown) where the pre-made pouch 10 is discharged from the form machine. The pouches may be loaded into a carrier and transferred to a filling machine. It should be appreciated that the filling machine may be integral with the pouch forming machine, or a separate machine. This portability increases the flexibility of the pouch and may result in a manufacturing cost savings. The methodology can next advance to a step where the pouch is transported to the filling machine.

At step 310 the end cap 130 or 140 can be placed in a holder 250 for moving the end cap and the tube formed at step 305 between filling stations. An example of a holder is a cup-shaped member, as disclosed in commonly assigned U.S. patent application Ser. No. 10/336,601, which is incorporated herein by reference.

At step 315, the tube formed at step 305 can be placed in the holder 250 and opened in an opening operation. In this example, the tube is located so that the outer surface 114 of the panel 110 is adjacent the inner surface 133 of the end cap 130. Various techniques are conventionally known in the art for opening the pouch 10. For example, the guide pocket formed by the crease in the panel facilitates opening of the pouch. A nozzle (not shown) may be mechanically lowered into the guide pocket to direct a stream of compressed gas into the guide pocket, to force the walls of the pouch 10 away from each other. An example of a gas is carbon dioxide or nitrogen. The blowing station may include a manifold, with a hood extending over the top of the edges of the pouch as known in the art. The manifold can have rows of apertures (not shown) above the upper edge 116 of the pouch 10. The hood is placed over the pouch 10 to assist in maintaining the air pressure in the pouch 10. The supply of pressurized gas is directed through the aperture to form a plurality of jets of pressurized gas or air. The jets can be directed downwardly onto diamond-shaped openings formed at the upper edge 116 in order to assist in overcoming the surface tension of the pouch and thereby aid in separating the panel walls. A diving rod (not shown) may then be used to make sure the pouch 10 is fully opened. If the pouch has a fitment, the gas can be injected through the spout fitment. After the pouch is opened, it may be injected with super-saturated steam to eliminate any pathogens or the like.

At step 320, the end cap 130 or 140 can be joined to the panel 110 as illustrated at reference numeral 113. The end cap may be sealed using an ultrasonic seal, a heat weld or the like. At step 325, the pouch 10 is filled with the product P in a filling operation. For example, a fill tube (not shown) can be lowered into the opened pouch 10 and the product is dispensed into the open pouch 10. The pouch may be filled through an open edge, or through a spout fitment, as previously described. If the pouch is large, the pouch may be filled at more than one station.

If the product is naturally carbonated, such as a sparkling wine or the like, the pouch is preferably filled while immersed in a nitrogen or carbon dioxide atmosphere. If the product is not naturally carbonated and carbonation is desirable, it is immersed in a carbonator to introduce carbon dioxide into the product. For example, carbon dioxide is introduced into cold water or juice to provide a carbonated beverage. The product may contain a mixture of up to four volumes of carbon dioxide. It should be appreciated that the carbon dioxide masks any undesirable taste from ketones and other solvents released during the sealing process. The carbon dioxide also increases the pressure within the product so that the walls of the pouch are rigid after the top is sealed. The product is preferably filled at a temperature ranging from 29° F. to ambient temperature. The filled pouch may have the oxygen removed from the pouch. For example, the pouch may be flushed with carbon dioxide as shown at step 330.

At step 335, the pouch can be sealed. In an example of a heat sealed pouch, the open edges of the pouch are closed by applying a first closing seal. The first closing seal may be an ultrasonic seal, or an ultra pulse seal. An example of a closing seal for a pouch containing a carbonated beverage, is described in commonly owned PCT Patent Application No. PCT/US03/034396 which is incorporated herein by reference. A second seal may be applied a predetermined distance apart from the first seal for a carbonated product. The second seal may be a heat weld or a cosmetic seal or an ultrasonic seal or the like. The location of the second seal is selected so that some of the product is trapped between the first and second seals. This is advantageous since it eliminates the potential for gas in the head space, i.e. the region between the product and the heat seal. In this example the second seal is spaced outboard of the first seal. Another advantage of the location of the second seal is that the overall length of the pouch may be reduced, resulting in less pouch material. The first closing seal is a tack seal, and the second closing seal is a high pressure, high temperature seal. A cosmetic seal may be applied with respect to the first and second closing seals, or the second seal may be a cosmetic seal.

In another example, the end cap 130 or 140 is placed on the upper edge 116 of the pouch 10 and sealed to the pouch, as previously described. The reinforcing tape 124 provides structural support for the pouch body, to receive the cap. The end cap seal may be an ultrasonic seal, or an ultra pulse seal, such as a heat weld or the like.

The methodology can then advance to one or more steps as indicated by the large arrow in FIG. 12 where the pouch 10 is finished in a finishing operation. For example, an edge of the pouch 10 may be trimmed to achieve a predetermined shape. In addition, the pouch 10 may be cooled at a cooling station, where the pouch 10 is cooled using a conventionally known cooling technique. Optionally, the sleeve may be placed over the filled pouch and shrunk to fit over the pouch by applying heat. The sleeve layer forms an outer layer of the pouch.

After the finishing operation(s), the filled pouch 10 can be discharged from the machine. A plurality of pouches may be placed in a package for sales or shipping purposes. The pouch may be discharged back into a carrier rack for storage or into a case packed for shipping.

It should be appreciated that the pouch may undergo other processing steps, such as such as an upstream oxygen purging station, downstream oxygen purging station, pasteurization or the like. For example, the filled pouch 10 may be pasteurized in integral retort chamber (not shown) that heats and then cools the pouch 10. The pouch 10 may be tested, such as burst testing or the like prior to packaging for shipping. These additional processing steps may take place at a station on the form/fill/seal apparatus, or on another apparatus.

It should be appreciated that the order of steps may vary depending on the pouch and its features. Also, a particular manufacturing station may perform one or a plurality of operations, to enhance the efficiency of the methodology and apparatus.

The fill machine illustrated is by way of example, and other configurations may be utilized. It should be appreciated that a particular manufacturing station may perform one or more operations. It should also be appreciated that the order of operations may vary. The fill-seal machine may be configured as a flat bed, a conveyor, a rotary turret or the like. An example of a flat bed form machine is manufactured by Nishibe, such as the model number SBM500, SMB600 or SMB700. It should be appreciated that the fill-seal machine may be integral with the form machine, or a separate machine.

The present invention has been described in an illustrative manner. It is to be understood that the terminology which has been used is intended to be in the nature of words of description rather than of limitation.

Many modifications and variations of the present invention are possible in light of the above teachings. Therefore, the present invention may be practiced other than as specifically described.

1. A flexible tube package comprising:
a panel having a pair of side edges, said panel rolled into a tube shape such that said pair of side edges are proximate each other;
a side seal extending along said pair of side edges, said side seal forming a tube out of said panel, said tube having a tube inner surface and a tube outer surface;
an elongated piece of reinforcement tape attached to at least one end of said tube;
a first end cap attached to one end of said tube;
a second end cap attached to an opposite end of said tube; and
an insert located within the flexible tube package, said insert selected from the group consisting of an absorbent layer, a flavor additive, a radio frequency identification label and combinations thereof.

2. The flexible tube package of claim 1, wherein said elongated piece of reinforcement tape is attached to said tube inner surface.

3. The flexible tube package of claim 1, wherein said first end cap has a side wall extending from an end portion.

4. The flexible tube package of claim 3, wherein said side wall has a side wall inner surface attached to said tube outer surface.

5. The flexible tube package of claim 1, wherein said absorbent layer is attached to said first end cap.

6. The flexible tube package of claim 5, wherein said first end cap has a false bottom, said insert located within said false bottom.

7. The flexible tube package of claim 5, wherein said first end cap has a perforated layer spaced apart from said end portion, said insert located between said end portion and said perforated layer.

8. The flexible tube package of claim 1, further comprising a pressure release valve, said pressure release valve operable to release an internal pressure from the flexible tube package.

9. The flexible tube package of claim 8, wherein said pressure release valve is part of said first end cap or said second end cap.

10. The flexible tube package of claim 1, further comprising a radio frequency identification tag attached to the flexible tube package.

11. A flexible tube package comprising:
a panel having a pair of side edges, said panel made from a laminate material and being rolled into a tube shape such that said pair of side edges are proximate and generally parallel to each other;
a side seal extending along said pair of side edges, said side seal forming a tube out of said panel, said tube having a tube inner surface and a tube outer surface;
an elongated piece of reinforcement tape attached to said tube inner surface and located adjacent to an end of said tube;
a first end cap attached to a first end of said tube, said first end cap having a end portion and a perorated layer spaced apart from said end portion, said end layer and said spaced apart perforated layer forming a false bottom;
a product located within said tube;
a second end cap attached to a second end of said tube; and
an insert located within said false bottom of said first end cap, said insert selected from the group consisting of an absorbent layer, a flavor additive, a radio frequency identification label and combinations thereof.

12. The flexible tube package of claim 11, wherein said first end cap has a side wall extending from an end portion.

13. The flexible tube package of claim 12, wherein said side wall has a side wall inner surface attached to said tube outer surface.

14. A process for making a flexible tube package comprising:
providing a roll of laminate material;
unrolling the roll of laminate material;
providing an elongated piece of reinforcement tape;
attaching the elongated piece of reinforcement tape onto the roll of laminate material;
cutting a panel out of the roll of laminate material, the panel having a pair of side edges and a pair of end edges with at least one of the pair of end edges being adjacent to and parallel with the elongated piece of reinforcement tape attached to the roll of laminate material;
rolling the panel into a tube shape such that the pair of side edges are proximate and generally parallel each other;
forming a side seal, the side seal extending along the pair of side edges and forming a tube out of the panel, the tube having a tube inner surface, a tube outer surface, a first open end and a second open end, the elongated piece of reinforcement tape attached to the tube inner surface adjacent to the first open end or the second open end;
providing a first end cap, the first end cap having a side wall extending from an end portion and a perforated layer spaced apart from the end portion such that a false bottom is formed in the first end cap;
providing an insert located between the end portion and the perforated layer of the first end cap, the insert selected from the group consisting of an absorbent layer, a flavor additive, a radio frequency identification label and combinations thereof;
providing a holder, the holder dimensioned to accept and hold the first end cap and the tube;
placing the first end cap into the holder;
placing the tube into the holder such that the first open end is in contact with the first end cap;
sealing the first end cap to the first open end of the tube in order to form a closed end tube;
filling the closed end tube with a product;
providing a second end cap;
placing the second end cap onto the tube such that the second end cap is in contact with the second open end of the tube; and
sealing the second end cap to the second open end of the tube in order to form a flexible tube package with an insert.

15. The process of claim 14, wherein the side wall of the first end cap has an inner surface that is sealed to the tube outer surface.

16. The process of claim 14, further including providing a pressure relief valve, the pressure relief valve operable to let pressure within the flexible tube package to be released out of the flexible tube package.

17. The process of claim 16, wherein the pressure relief valve is integral with the second end cap.

18. The process of claim 14, further including providing a radio frequency identification tag attached to the flexible tube package.
